(19) United States
(12) Patent Application Publication
(10) Pub. No.: US 2025/0244143 A1
(43) Pub. Date: Jul. 31, 2025

(54) JUDGMENT DEVICE, JUDGMENT METHOD, AND STORAGE MEDIUM

(71) Applicant: HONDA MOTOR CO., LTD., Tokyo (JP)

(72) Inventors: Takahiro Shimizu, Tokyo (JP); Sho Tamura, Tokyo (JP)

(21) Appl. No.: 19/023,452

(22) Filed: Jan. 16, 2025

(30) Foreign Application Priority Data
Jan. 25, 2024 (JP) 2024-009782

(51) Int. Cl. G01C 21/00

(52) U.S. Cl. CPC G01C 21/3859; G01C 21/3819

(57) ABSTRACT

A judgment device includes a storage medium storing computer readable commands, and a processor connected to the storage medium. The processor executes the computer readable commands to recognize a road division line present in a proceeding direction of a vehicle, and to judge whether or not the recognized road division line is consistent with a map road division line based on map information stored in a storage unit. When the vehicle is traveling on a curved road, the processor sets a distance from the vehicle to a far end part on a side in the proceeding direction of the vehicle of a judgment range in which the judgment is performed to be shorter than the distance when the vehicle is not traveling on a curved road.

### CROSS-REFERENCE TO RELATED APPLICATION

Priority is claimed on Japanese Patent Application No. 2024-009782, filed Jan. 25, 2024, the content of which is incorporated herein by reference.

### BACKGROUND

### Field of the Invention

The present invention relates to a judgment device, a judgment method, and a storage medium.

### Description of Related Art

In recent years, efforts to provide access to sustainable transportation systems taking vulnerable people among traffic participants into account have become active. In order to realize this, the efforts are focused on research and development for further improvement in traffic safety and convenience through research and development related to autonomous driving technology.

Incidentally, in the autonomous driving technology, consistency between a road division line recognized from camera images and a road division line recognized from map information is checked, and the results are used for generating a target trajectory of a host vehicle. However, there is a problem that a road division line recognized from camera images is likely to be misrecognized when the host vehicle is traveling on a curved road or a branch road, for example. In order to cope with this problem, for example, Japanese Unexamined Patent Application, First Publication No. 2017-068617 discloses that image recognition on a branching side is restricted when the position of a host vehicle is present in a section of a branch road. Moreover, Japanese Unexamined Patent Application, First Publication No. 2018-200501 discloses that when continuity evaluation of an actual boundary obtained from recognition ranges in front and behind a host vehicle and a map boundary is high while traveling on a curved road, information of these is integrated and used, whereas when the evaluation is low, the map boundary is used.

However, in these technologies in the related art, all road shapes which are difficult to be recognized are set as detection restraint ranges, and as a result of excessive restraint, recognition accuracy of a road division line may be degraded.

### SUMMARY

The present invention has been made in consideration of such circumstances, and an object thereof is to provide a judgment device, a judgment method, and a storage medium capable of appropriately setting a recognition range of a camera road division line while a host vehicle is traveling on a curved road. Further, this will ultimately contribute to development of sustainable transportation systems.

A judgment device according to this invention employs the following constitutions.

(1): A judgment device according to an aspect of this invention includes a storage medium storing computer readable commands, and a processor connected to the storage medium. The processor executes the computer readable commands to recognize a road division line present in a proceeding direction of a vehicle, and to judge whether or not the recognized road division line is consistent with a map road division line based on map information stored in a storage unit. When the vehicle is traveling on a curved road, the processor sets a distance from the vehicle to a far end part on a side in the proceeding direction of the vehicle of a judgment range in which the judgment is performed to be shorter than the distance when the vehicle is not traveling on a curved road.

(2): According to the aspect of the foregoing (1), the processor sets the distance to the far end part of the judgment range in accordance with a gradient of the curved road.

(3): According to the aspect of the foregoing (2), the processor sets, as the distance to the far end part, a distance to a position where a difference in a vehicle width direction between the map road division line and a gradient map road division line obtained by correcting the map road division line in accordance with the gradient becomes equal to or greater than a prescribed value.

(4): According to the aspect of the foregoing (2), the processor sets, as the distance to the far end part, a distance to a position at a predetermined distance near from a position where a difference in a vehicle width direction between the map road division line and a gradient map road division line obtained by correcting the map road division line in accordance with the gradient becomes equal to or greater than a prescribed value.

(5): According to the aspect of the foregoing (1), the processor identifies a contact point where a line extending from a predetermined position in the vehicle comes into contact with a road division line of the recognized road division lines on an inward side of the curved road. The processor sets the distance to the far end part of the judgment range in accordance with a position of the contact point.

(6): According to the aspect of the foregoing (5), the processor sets, as the distance to the far end part, a distance to a position at a predetermined distance far away from the position of the contact point of the judgment range.

(7): According to the aspect of the foregoing (1), the processor sets the distance to the far end part of the judgment range in accordance with a curving degree of the curved road.

(8): According to the aspect of the foregoing (7), the processor shortens the distance to the far end part as the curving degree of the curved road increases.

(9): According to the aspect of the foregoing (1), the processor identifies a contact point where a line extending from a predetermined position in the vehicle comes into contact with a road division line of the recognized road division lines on an inward side of the curved road. The processor sets a first candidate for the far end part in accordance with a gradient of the curved road, sets a second candidate for the far end part in accordance with a position of the contact point, and sets a third candidate for the far end part in accordance with a curving degree of the curved road. The processor sets, as the far end part, a candidate of at least two of the first candidate, the second candidate, and the third candidate present on a side near the vehicle.

(10): According to the aspect of the foregoing (9), the processor sets, as the first candidate, a position where a difference in a vehicle width direction between the map road division line and a gradient map road division line obtained by correcting the map road division line in accordance with the gradient becomes equal to or greater than a prescribed value, and the processor sets, as the second candidate, a position at a predetermined distance far away from the position of the contact point.

(11): According to the aspect of the foregoing (9) or (10), the processor sets, as the third candidate, a position set in accordance with the curving degree of the curved road.

(12): In a judgment method according to another aspect of this invention, a computer mounted in a vehicle recognizes a road division line present in a proceeding direction of the vehicle, judges whether or not the recognized road division line is consistent with a map road division line based on map information stored in a storage unit, and sets, when the vehicle is traveling on a curved road, a distance from the vehicle to a far end part on a side in the proceeding direction of the vehicle of a judgment range in which the judgment is performed to be shorter than the distance when the vehicle is not traveling on a curved road.

(13): A computer readable non-transitory storage medium according to another aspect of this invention stores a program for causing a computer mounted in a vehicle to recognize a road division line present in a proceeding direction of the vehicle, to judge whether or not the recognized road division line is consistent with a map road division line based on map information stored in a storage unit, and to set, when the vehicle is traveling on a curved road, a distance from the vehicle to a far end part on a side in the proceeding direction of the vehicle of a judgment range in which the judgment is performed to be shorter than the distance when the vehicle is not traveling on a curved road.

According to the aspects of the foregoing (1) to (13), a recognition range of a camera road division line can be appropriately set while a host vehicle is traveling on a curved road.

According to the aspects of the foregoing (2) to (4), the recognition range of the camera road division line can be appropriately set in accordance with the gradient of a curved road.

According to the aspects of the foregoing (5) to (8), the recognition range of the camera road division line can be appropriately set in accordance with the curving degree of a curved road.

According to the aspects of the foregoing (9) to (11), the recognition range of the camera road division line can be appropriately set in accordance with the gradient and the curving degree of a curved road.

### BRIEF DESCRIPTION OF THE DRAWINGS

FIG. 1 is a view of a constitution of a vehicle system utilizing a judgment device according to an embodiment.

FIG. 2 is a view of a functional constitution of a first control unit and a second control unit.

FIG. 3 is a view of showing an example of a correspondence of driving modes, control states of a host vehicle, and tasks.

FIG. 4 is a view of showing an example of a scene of judgment processing executed by a judgment unit 132.

FIG. 5 is a view of showing another example of a scene of the judgment processing executed by the judgment unit 132.

FIG. 6 is an explanatory view of a method for selecting a far end part by the judgment unit 132. FIG. 7 is a flowchart showing an example of a flow of processing executed by the judgment unit 132.

FIG. 8 is an explanatory view of the method for selecting the far end part by the judgment unit 132 according to a modification example.

### DESCRIPTION OF EMBODIMENTS

Hereinafter, with reference to the drawings, an embodiment of a judgment device, a judgment method, and a storage medium according to the present invention will be described.

### Overall Constitution

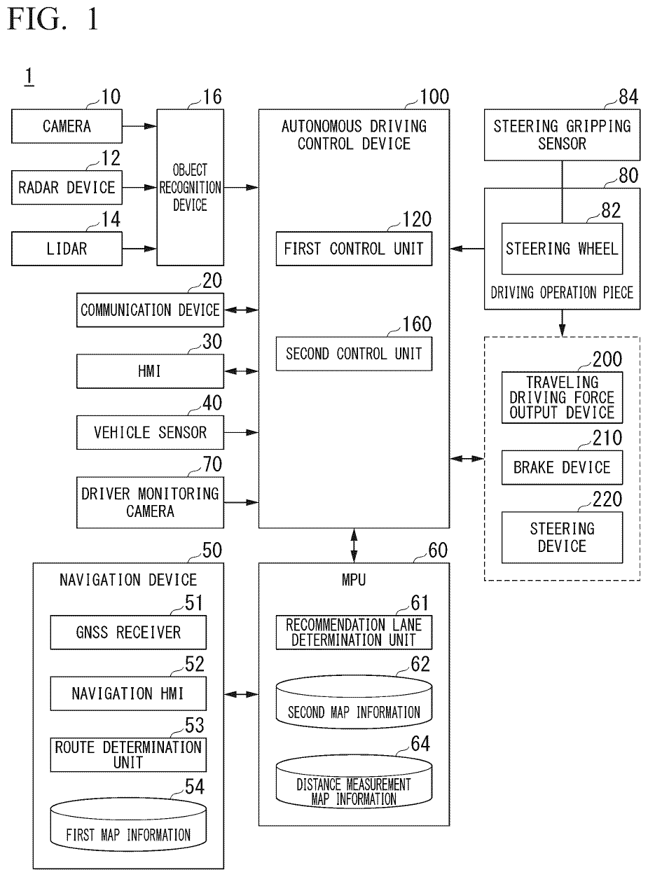

FIG. 1 is a view of a constitution of a vehicle system 1 utilizing the judgment device according to an embodiment. A vehicle in which the vehicle system 1 is mounted is a vehicle, for example, having two wheels, three wheels, four wheels, or the like, and a drive source thereof is an internal-combustion engine such as a diesel engine or a gasoline engine, an electric motor, or a combination of these. An electric motor is operated using power generated by a generator connected to an internal-combustion engine, or discharge power of a secondary battery or a fuel cell.

For example, the vehicle system 1 includes a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitoring camera 70, a driving operation piece 80, an autonomous driving control device 100, a traveling driving force output device 200, a brake device 210, and a steering device 220. These devices and instruments are connected to each other through a multiplex communication line such as a controller area network (CAN) communication line, a serial communication line, a wireless communication network, or the like. The constituents shown in FIG. 1 are merely an example. Some of the constituents may be omitted, and other constituents may further be added thereto.

For example, the camera 10 is a digital camera utilizing a solid-state image capturing element such as a charge coupled device (CCD) or a complementary metal oxide semiconductor (CMOS). The camera 10 is attached to an arbitrary location in the vehicle in which the vehicle system 1 is mounted (hereinafter, a host vehicle M). When images on the side in front are captured, the camera 10 is attached to an upper part of a front windshield, a rear surface of a rearview mirror, or the like. For example, the camera 10 captures images around the host vehicle M periodically and repeatedly. The camera 10 may be a stereo camera.

The radar device 12 radiates radio waves such as millimeter waves around the host vehicle M and detects at least the position (distance and azimuth) of an object by detecting radio waves (reflected waves) reflected by the object. The radar device 12 is attached to an arbitrary location in the host vehicle M. The radar device 12 may detect the position and the speed of an object by a frequency modulated continuous wave (FM-CW) method.

The LIDAR 14 emits light (or electromagnetic waves having wavelengths close to that of light) around the host vehicle M and measures scattered light. The LIDAR 14 detects the distance to a target on the basis of the time from light emission to light reception. For example, emitted light is pulsed laser light. The LIDAR 14 is attached to an arbitrary location in the host vehicle M.

The object recognition device 16 recognizes the position, the kind, the speed, and the like of an object by performing sensor fusion processing with respect to detection results of some or all of the camera 10, the radar device 12, and the LIDAR 14. The object recognition device 16 outputs recognition results to the autonomous driving control device 100. The object recognition device 16 may output the detection results of the camera 10, the radar device 12, and the LIDAR 14 to the autonomous driving control device 100 without any change. The object recognition device 16 may be omitted from the vehicle system 1.

For example, the communication device 20 communicates with different vehicles present around the host vehicle M utilizing a cellular network, a Wi-Fi network, Bluetooth (registered trademark), dedicated short range communication (DSRC), or the like or communicates with various server devices via a wireless base station.

The HMI 30 provides various information to an occupant of the host vehicle M and receives an input operation of the occupant. The HMI 30 includes various display devices, a speaker, a buzzer, a touch panel, a switch, a key, and the like.

The vehicle sensor 40 includes a vehicle speed sensor for detecting a speed of the host vehicle M, an acceleration sensor for detecting an acceleration, a yaw rate sensor for detecting an angular velocity around a vertical axis, an azimuth sensor for detecting a direction of the host vehicle M, and the like.

For example, the navigation device 50 includes a global navigation satellite system (GNSS) receiver 51, a navigation HMI 52, and a route determination unit 53. In the navigation device 50, first map information 54 is retained in a storage device such as a hard disk drive (HDD) or a flash memory. The GNSS receiver 51 identifies the position of the host vehicle M on the basis of a signal received from a GNSS satellite.

The position of the host vehicle M may be identified or completed by an inertial navigation system (INS) utilizing an output of the vehicle sensor 40. The navigation HMI 52 includes a display device, a speaker, a touch panel, a key, and the like. Some or all of the navigation HMI 52 may be shared by the HMI 30 described above. For example, the route determination unit 53 determines a route from the position of the host vehicle M identified by the GNSS receiver 51 (or an arbitrary input position) to a destination input by an occupant (hereinafter, a route on a map) using the navigation HMI 52 with reference to the first map information 54. For example, the first map information 54 is information in which road shapes are expressed by links indicating roads and nodes connected by the links. The first map information 54 may include curvatures of roads, point-of-interest (POI) information, and the like. The route on the map is output to the MPU 60. The navigation device 50 may perform route guidance using the navigation HMI 52 on the basis of the route on the map. For example, the navigation device 50 may be realized by a function of a terminal device such as a smartphone or a tablet terminal possessed by an occupant. The navigation device 50 may transmit a current position and a destination to a navigation server via the communication device 20 and acquire a route equivalent to the route on the map from the navigation server.

For example, the MPU 60 includes a recommended lane determination unit 61 and retains second map information 62 and distance measurement map information 64 in a storage device such as an HDD or a flash memory. The recommended lane determination unit 61 divides the route on the map provided from the navigation device 50 into a plurality of blocks (for example, divides it into blocks of 100 [m] in a vehicle proceeding direction) and determines a recommended lane for each block with reference to the second map information 62. The recommended lane determination unit 61 determines in which lane from the left the vehicle should travel. When a branch point is present in the route on the map, the recommended lane determination unit 61 determines a recommended lane such that the host vehicle M can travel along a reasonable route to proceed to a branch destination.

The second map information 62 is map information that is more accurate than the first map information 54. For example, the second map information 62 includes information of the center of a lane, information of the boundary of a lane, and the like. In addition, the second map information 62 may include road information, traffic regulation information, address information (address, postal code), facility information, telephone number information, information of prohibited sections in which a mode A or a mode B (which will be described below) is prohibited, and the like. The second map information 62 may be updated at any time by the communication device 20 through communication with other devices.

Similar to the second map information 62, the distance measurement map information 64 is map information which includes information of the center of a lane, information of the boundary of a lane, and the like, and in which the gradient information (for example, values such as altitude) has been recorded in advance in association with each position of the lane. When the host vehicle M is traveling on a curved road, a judgment unit 132 (which will be described below) corrects the boundary of a lane where the host vehicle M is positioned on the basis of the gradient information and converts it into a boundary of a lane from the viewpoint of the host vehicle M taking the gradient of the lane into account. Hereinafter, the information of the boundary of a lane obtained from the second map information 62 may be referred to as “a map road division line”, and the information of the boundary of a lane obtained by correcting the boundary of the lane stored in the distance measurement map information 64 on the basis of the gradient information may be referred to as “a gradient map road division line”. The gradient map road division line can be expressed as a predicted boundary of a lane from the viewpoint of the host vehicle M recognized by the camera 10 using the gradient information recorded in the distance measurement map information 64. In addition, as another form, the gradient map road division line can also be expressed as a map road division line corrected using the gradient information recorded in the distance measurement map information 64.

For example, the driver monitoring camera 70 is a digital camera utilizing a solid-state image capturing element such as a CCD or a CMOS. The driver monitoring camera 70 is attached to an arbitrary location in the host vehicle M in a position and a direction in which images of the head of an occupant seated in a driver's seat (hereinafter, a driver) of the host vehicle M can be captured from the front (in a direction in which images of the face are captured). For example, the driver monitoring camera 70 is attached to an upper part of the display device provided in the central part of an instrument panel of the host vehicle M.

For example, the driving operation piece 80 includes a steering wheel 82 as well as an accelerator pedal, a brake pedal, a shift lever, and other operation pieces. A sensor for detecting an amount of operation or whether there is an operation is attached to the driving operation piece 80, and detection results thereof are output to the autonomous driving control device 100 or some or all of the traveling driving force output device 200, the brake device 210, and the steering device 220. The steering wheel 82 is an example of “an operation piece receiving a steering operation of the driver”. The operation piece does not necessarily have an annular shape and may be in a form of a deformed steering wheel, a joystick, a button, or the like. A steering gripping sensor 84 is attached to the steering wheel 82. The steering gripping sensor 84 is realized by an electrostatic capacitance sensor or the like and outputs a signal capable of detecting whether or not the driver is gripping the steering wheel 82 (indicating that the driver is in contact with it in a state where a force can be applied thereto) to the autonomous driving control device 100.

For example, the autonomous driving control device 100 includes a first control unit 120 and a second control unit 160. Each of the first control unit 120 and the second control unit 160 is realized by a hardware processor such as a central processing unit (CPU), for example, executing a program (software). In addition, some or all of these constituent elements may be realized by hardware (circuit; including circuitry) such as a large scale integration (LSI), an application specific integrated circuit (ASIC), a field-programmable gate array (FPGA), a graphics processing unit (GPU), or a system on chip (SOC), or may be realized by software and hardware in cooperation. The program may be stored in a storage device such as an HDD or a flash memory (a storage device including a non-transitory storage medium) of the autonomous driving control device 100 in advance or may be stored in an attachable/detachable storage medium such as a DVD or a CD-ROM such that the program is installed in the HDD or the flash memory of the autonomous driving control device 100 when the storage medium (non-transitory storage medium) is mounted in a drive device. The autonomous driving control device 100 including the judgment unit 132 (which will be described below) is an example of “a judgment device”.

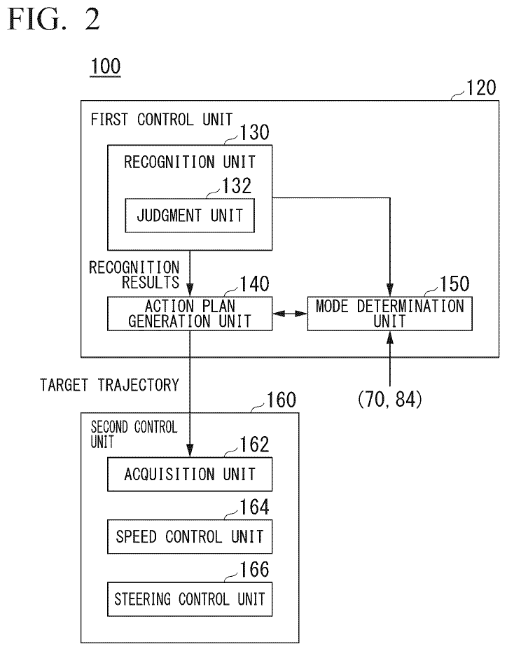

FIG. 2 is a view of a functional constitution of the first control unit 120 and the second control unit 160. For example, the first control unit 120 includes a recognition unit 130, the judgment unit 132, an action plan generation unit 140, and a mode determination unit 150. For example, the first control unit 120 realizes a function based on artificial intelligence (AI) and a function based on a model which has been given in advance in parallel. For example, a function of “recognizing an intersection” may be realized by executing recognition of an intersection using deep learning or the like and recognition based on conditions which have been given in advance (such as traffic lights, road signs, or the like which can be subjected to pattern matching) in parallel, scoring both, and evaluating them comprehensively. Accordingly, reliability of autonomous driving is ensured.

The recognition unit 130 recognizes the states of the position, the speed, the acceleration, and the like of an object around the host vehicle M on the basis of information input from the camera 10, the radar device 12, and the LIDAR 14 via the object recognition device 16. For example, the position of an object is recognized as a position on absolute coordinates with an origin at a representative point (the centroid, the drive shaft center, or the like) in the host vehicle M and is used for control. The position of an object may be represented by a representative point such as the centroid or a corner of the object or may be represented as a region. A “state” of an object may include an acceleration or a jerk of the object or “an action state” (for example, whether or not it is making a lane change or attempting a lane change).

In addition, for example, the recognition unit 130 recognizes a lane in which the host vehicle M is traveling (traveling lane). For example, the recognition unit 130 recognizes a traveling lane by comparing a pattern of a road division line obtained from the second map information 62 (which may hereinafter be referred to as “a map road division line”) with a pattern of a road division line around the host vehicle M recognized from an image captured by the camera 10 (which may hereinafter be referred to as “a camera road division line”). More specifically, for example, the judgment unit 132 of the recognition unit 130 calculates a deviation between the map road division line and the camera road division line, and when it is judged that the calculated deviation is equal to or smaller than a threshold (that is, when it is judged that they are consistent with each other), any one of the map road division line and the camera road division line (or a median line thereof or the like) is recognized as the traveling lane. Details of comparison processing of the camera road division line and the camera road division line by the judgment unit 132 will be described below. The recognition unit 130 may recognize a traveling lane by recognizing a traveling path boundary (road boundary) including road division lines, road shoulders, curbstones, median strips, guardrails, and the like without being limited to road division lines. In this recognition, a position of the host vehicle M acquired from the navigation device 50 or processing results of the INS may be added. In addition, the recognition unit 130 recognizes stop lines, obstacles, red lights, toll gates, and other road events.

When recognizing a traveling lane, the recognition unit 130 recognizes a position or a posture of the host vehicle M with respect to the traveling lane. For example, the recognition unit 130 may recognize the deviation of a reference point in the host vehicle M from the center of the lane and an angle formed with respect to a line of the centers of the lane of the host vehicle M in the proceeding direction as a relative position and a posture of the host vehicle M with respect to the traveling lane. Instead of this, recognition unit 130 may recognize a position or the like of a reference point in the host vehicle M with respect to any side end part (a road division line or a road boundary) of the traveling lane as a relative position of the host vehicle M with respect to the traveling lane.

In principle, the action plan generation unit 140 generates a target trajectory in which the host vehicle M will travel autonomously (without relying on an operation of the driver) in the future so as to travel in a recommended lane determined by the recommended lane determination unit 61 and further avoid approaching any object recognized by the recognition unit 130 (excluding those which can be overcome, such as a road division line, a road sign, or a manhole). For example, the recognition unit 130 sets a risk region centered on an object whose state has been output, and a risk is set by the recognition unit 130 as an index value indicating a degree to which the host vehicle M should not approach within the risk region. The action plan generation unit 140 generates a target trajectory such that the host vehicle M does not pass through a spot where the risk is equal to or greater than a predetermined value and travels within a recognized traveling lane. Since objects include moving bodies, the risk distribution is not one per control cycle so that it is set for a plurality of points of time in the future taking into account the position of an object in the future which has been predicted on the basis of the speed of the object. For example, a target trajectory is expressed as an ordered sequence of spots (trajectory points) at which the host vehicle M should arrive. The trajectory points are spots at which the host vehicle M should arrive at intervals of a predetermined traveling distance (for example, approximately several [m]) along a road, and separately, a target speed and a target acceleration at intervals of a predetermined sampling time (for example, approximately a few tenths of [sec]) are generated as a part of the target trajectory. In addition, the trajectory points may be positions which are set at intervals of a predetermined sampling time and at which the host vehicle M should arrive at each sampling time. In this case, information of the target speed and the target acceleration is expressed by the intervals between the trajectory points.

When a target trajectory is generated, the action plan generation unit 140 may set events of autonomous driving. Events of autonomous driving include a constant speed traveling event, a low-speed following traveling event, a lane change event, a branching event, a merging event, a takeover event, and the like. The action plan generation unit 140 generates a target trajectory corresponding to a started event.

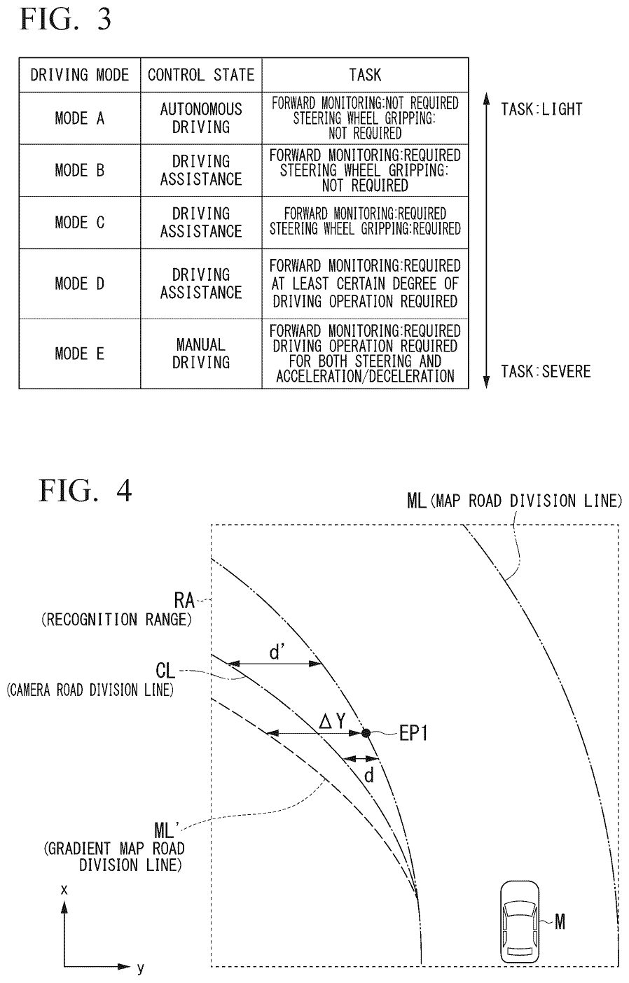

The mode determination unit 150 determines the driving mode of the host vehicle M to be one of a plurality of driving modes in which different tasks are imposed on the driver. FIG. 3 is a view of showing an example of a correspondence of driving modes, control states of the host vehicle M, and tasks. The host vehicle M has five driving modes, such as the mode A to the mode E, for example. The control state, that is, the degree of automation of driving control of the host vehicle M is the highest in the mode A, followed by the mode B, the mode C, and the mode D in decreasing order, and is the lowest in the mode E. Conversely, the task imposed on the driver is the lightest in the mode A, followed by the mode B, the mode C, and the mode D in increasing order of severity, and is the most severe in the mode E. In the modes D and E, since the vehicle is in the control state of non-autonomous driving, the autonomous driving control device 100 is responsible for ending the control related to autonomous driving and shifting to driving assistance or manual driving. Hereinafter, contents of each driving mode will be described as an example.

In the mode A, the vehicle is in an autonomous driving state, and neither forward monitoring nor gripping the steering wheel 82 (in the diagram, steering wheel gripping) is imposed on the driver. However, even in the mode A, the driver is requested to be in a posture in which he/she can promptly shift to manual driving in response to a request from the system centered on the autonomous driving control device 100. The said term “autonomous driving” refers to a state where neither steering nor acceleration/deceleration is controlled without relying on an operation of the driver. The term “forward” means a space in the proceeding direction of the host vehicle M visually recognized through the front windshield. For example, the mode A is a driving mode which can be executed when the host vehicle M is traveling at a predetermined speed (for example, approximately 50 [km/h]) or slower on a motorway such as an express way, and when conditions, such as the presence of a preceding vehicle that is a following target, are satisfied, and may also be referred to as a traffic jam pilot (TJP). When the conditions are no longer satisfied, the mode determination unit 150 changes the driving mode of the host vehicle M to the mode B.

In the mode B, the vehicle is in a driving assistance state, and the task of monitoring ahead of the host vehicle M (hereinafter, forward monitoring) is imposed on the driver, but the task of gripping the steering wheel 82 is not imposed. In the mode C, the vehicle is in a driving assistance state, and the task of forward monitoring and the task of gripping the steering wheel 82 are imposed on the driver. The mode D is a driving mode requiring a certain degree of driving operation by the driver for at least one of steering and acceleration/deceleration of the host vehicle M. For example, in the mode D, driving assistance such as adaptive cruise control (ACC) or lane keeping assist system (LKAS) is performed. In the mode E, the vehicle is in a manual driving state requiring a driving operation by the driver for both steering and acceleration/deceleration. In both the mode D and the mode E, the task of monitoring ahead of the host vehicle M is naturally imposed on the driver.

The driving modes are not limited to those shown in FIG. 3 as an example and may be stipulated by other definitions. For example, the driving modes requiring both forward monitoring and steering wheel gripping may include a driving mode with a lenient threshold and a driving mode with a strict threshold for judging that the steering wheel is being gripped. More specifically, the driving modes may be defined such that the driver need only touch the steering wheel 82 with either the left or right hand in a certain driving mode, while the driver needs to grab the steering wheel 82 with both hands with a strength equal to or greater than a threshold in another driving mode in which the task imposed on the driver is more severe. Furthermore, the driving modes having different severity of tasks imposed on the driver may be defined in any manner.

The autonomous driving control device 100 (and a driving assistance device (not shown)) executes an automatic lane change corresponding to the driving mode. The automatic lane change includes an automatic lane change (1) requested by the system, and an automatic lane change (2) requested by the driver. The automatic lane change (1) includes an automatic lane change for overtaking performed when the speed of a preceding vehicle is lower than the speed of the host vehicle by a criterion, and an automatic lane change for proceeding toward a destination (an automatic lane change due to change in the recommended lane). In the automatic lane change (2), when conditions related to the speed, the positional relationship with respect to surrounding vehicles, and the like are satisfied, the host vehicle M is caused to make a lane change in an operation direction when a direction indicator is operated by the driver. In the mode A, the autonomous driving control device 100 executes none of the automatic lane changes (1) and (2). In the modes B and C, the autonomous driving control device 100 executes both the automatic lane changes (1) and (2). In the mode D, the driving assistance device (not shown) does not execute the automatic lane change (1) but executes the automatic lane change (2). In the mode E, none of the automatic lane changes (1) and (2) is executed.

When the task related to the determined driving mode (hereinafter, a current driving mode) is not executed by the driver, the mode determination unit 150 changes the driving mode of the host vehicle M to a driving mode with a more severe task.

For example, in the mode A, when the driver is in a posture in which he/she cannot shift to manual driving in response to a request from the system (for example, when he/she continues to look elsewhere other than an allowance area, or when a sign of difficulty in driving is detected), the mode determination unit 150 prompts the driver to shift to manual driving using the HMI 30, and if the driver does not respond, control such as pulling over the host vehicle M to a road shoulder, gradually stopping it, and stopping the autonomous driving is performed. After the autonomous driving has been stopped, the host vehicle is in the state of the mode D or E so that the host vehicle M can be started by a manual operation of the driver. Hereinafter, the same applies to “stopping autonomous driving”. In the mode B, when the driver is not monitoring forward, the mode determination unit 150 prompts the driver to perform forward monitoring using the HMI 30, and if the driver does not respond, control such as pulling over the host vehicle M to a road shoulder, gradually stopping it, and stopping the autonomous driving is performed. In the mode C, when the driver is not monitoring forward, or when the driver is not gripping the steering wheel 82, the mode determination unit 150 prompts the driver to perform forward monitoring and/or to grip the steering wheel 82 using the HMI 30, and if the driver does not respond, control such as pulling over the host vehicle M to a road shoulder, gradually stopping it, and stopping the autonomous driving is performed.

The mode determination unit 150 further monitors the state of the driver for the foregoing mode change and judges whether or not the state of the driver is a state corresponding to the task. For example, the mode determination unit 150 analyzes images captured by the driver monitoring camera 70 and performs posture estimation processing, thereby judging whether or not the driver is in a posture in which he/she cannot shift to manual driving in response to a request from the system. In addition, a driver state judgment unit 152 analyzes images captured by the driver monitoring camera 70 and performs visual line estimation processing, thereby judging whether or not the driver is monitoring forward.

In addition, in the present embodiment, when the judgment unit 132 judges that the map road division line and the camera road division line are not consistent with each other, the mode determination unit 150 changes the driving mode of the host vehicle M to a driving mode with a more severe task. For example, when it is judged that the map road division line and the camera road division line are not consistent with each other while the host vehicle M is traveling in a driving mode not requiring steering wheel gripping (mode A or mode B), the mode determination unit 150 changes the driving mode to the mode D or the mode E.

The mode determination unit 150 further performs various processing for a mode change. For example, the mode determination unit 150 instructs the action plan generation unit 140 to generate a target trajectory for stopping at a road shoulder, instructs the driving assistance device (not shown) to activate, or controls the HMI 30 to prompt the driver to act.

The second control unit 160 controls the traveling driving force output device 200, the brake device 210, and the steering device 220 such that the host vehicle M passes through the target trajectory generated by the action plan generation unit 140 at the scheduled time.

Returning to FIG. 2, for example, the second control unit 160 includes an acquisition unit 162, a speed control unit 164, and a steering control unit 166. The acquisition unit 162 acquires information of a target trajectory (trajectory points) generated by the action plan generation unit 140 and stores it in a memory (not shown). The speed control unit 164 controls the traveling driving force output device 200 or the brake device 210 on the basis of a speed element associated with the target trajectory stored in the memory. The steering control unit 166 controls the steering device 220 in accordance with the curvature of the target trajectory stored in the memory. For example, processing of the speed control unit 164 and the steering control unit 166 is realized by a combination of feedforward control and feedback control. As an example, the steering control unit 166 executes a combination of feedforward control corresponding to the curvature of the road ahead of the host vehicle M and feedback control based on the deviation from the target trajectory.

The traveling driving force output device 200 outputs a traveling driving force (torque) for the vehicle to travel to driving wheels. For example, the traveling driving force output device 200 includes a combination of an internal-combustion engine, an electric motor, a transmission, and the like, and an electronic control unit (ECU) for controlling these. The ECU controls the foregoing constituents in accordance with the information input from the second control unit 160 or the information input from the driving operation piece 80.

For example, the brake device 210 includes a brake caliper, a cylinder transmitting a hydraulic pressure to the brake caliper, an electric motor generating a hydraulic pressure in the cylinder, and a brake ECU. The brake ECU controls the electric motor in accordance with the information input from the second control unit 160 or the information input from the driving operation piece 80 so that a brake torque corresponding to a braking operation is output to each of the wheels. The brake device 210 may include, as a backup, a mechanism for transmitting a hydraulic pressure generated by an operation of the brake pedal included in the driving operation piece 80 to the cylinder via a master cylinder. The brake device 210 is limited to the constitution described above and may be an electronically controlled hydraulic brake device transmitting a hydraulic pressure of the master cylinder to the cylinder by controlling an actuator in accordance with the information input from the second control unit 160.

For example, the steering device 220 includes a steering ECU and an electric motor. For example, the electric motor causes a force to act on a rack-and-pinion mechanism to change the direction of steered wheels. The steering ECU drives the electric motor in accordance with the information input from the second control unit 160 or the information input from the driving operation piece 80 to change the direction of the steered wheels.

[Processing when Traveling on Curved Road]

As described above, the judgment unit 132 compares the map road division line obtained from the second map information 62 and the camera road division line recognized from camera images and judges whether or not they are consistent with each other. When it is judged that the map road division line and the camera road division line are consistent with each other, the action plan generation unit 140 generates a target trajectory of the host vehicle M to travel in the traveling lane along the map road division line or the camera road division line. However, for example, when the host vehicle M is traveling on a curved road (more generally, a traveling path in which change in curvature of the division line becomes equal to or greater than a threshold), misrecognition is likely to occur particularly in the camera road division lines present far away in the proceeding direction of the host vehicle M so that inconsistency may be judged between the map road division line and the camera road division line. As a result, even when the misrecognition is actually rectified with the lapse of time and there is no need to change the driving mode, the mode determination unit 150 changes the driving mode of the host vehicle M to a driving mode with a more severe task, which may impair the convenience for the driver.

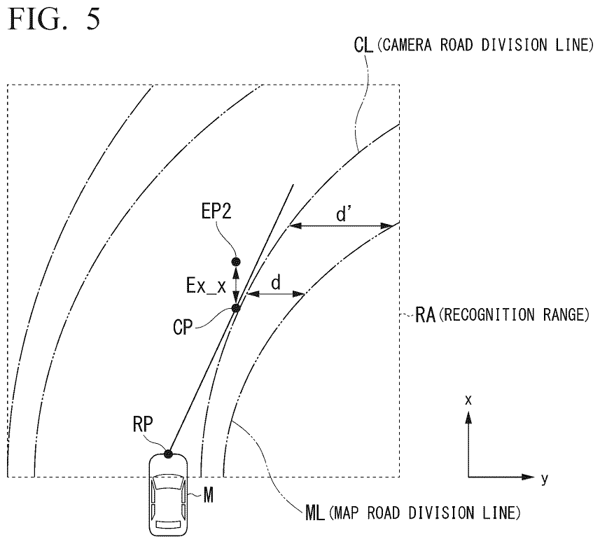

With this as a background, when it is judged on the basis of the second map information 62 that the host vehicle M is traveling on a curved road, the judgment unit 132 sets a distance from the host vehicle M to a far end part on a side in the proceeding direction of the host vehicle M within a range of the camera road division line recognized by the recognition unit 130 (which may hereinafter be referred to as “a judgment range”) to be shorter than the distance when the vehicle is not traveling on a curved road. At this time, the end part of the judgment range on a near side may be a predetermined location on the host vehicle M or may be at a predetermined distance ahead of it. In addition, the judgment unit 132 may judge that the host vehicle M is traveling on a curved road on the basis of registration information indicating the curved road stored in the second map information 62 or may judge that the host vehicle M is traveling on a curved road when the calculated curvature becomes equal to or greater than a threshold after calculating the curvature of the traveling path in which the host vehicle M is traveling from the traveling path information stored in the second map information 62. Hereinafter, with reference to FIGS. 4 to 6, details of judgment processing by the judgment unit 132 will be described.

FIG. 4 is a view of showing an example of a scene of judgment processing executed by the judgment unit 132. In FIG. 4, a reference sign CL represents a camera road division line recognized by the recognition unit 130, a reference sign ML represents a map road division line, and a reference sign ML′ represents a gradient map road division line. FIG. 4, as an example, shows a situation in which the map road division line deviates from the camera road division line and the gradient map road division line due to the downward gradient of the curved road where the host vehicle M is traveling, and ΔY indicates the deviation in a vehicle width direction Y between the map road division line ML and the gradient map road division line ML′. As the gradient value of the curved road increases, the deviation ΔY also increases. Ultimately, the deviation between the map road division line ML and the camera road division line CL (in other words, misrecognition of the camera road division line CL) tends to increase as well. In addition, generally, if a curved road has a downward gradient, the gradient map road division line ML′ tends to deviate to the inward side of the curve, and if a curved road has an upward gradient, it tends to deviate to the outward side of the curve.

For this reason, the judgment unit 132 identifies a point EP1 which is a point on the map road division line ML and at which the deviation ΔY becomes equal to or greater than a prescribed value while the host vehicle M is traveling on a curved road. Here, the prescribed value is a value indicating a limiting point of an allowance range of the misrecognition of the camera road division line CL used for matching with the map road division line ML. If the point EP1 at which the deviation ΔY becomes equal to or greater than the prescribed value is identified, the judgment unit 132 sets the point EP1 as a far end part of a range for matching the camera road division line CL and the map road division line ML in a recognition range RA.

Next, the judgment unit 132 judges whether or not the camera road division line CL and the map road division line ML are consistent with each other in a range nearer than the far end part EP1 in a proceeding direction X of the host vehicle M in the recognition range RA. Accordingly, in the case of FIG. 4, in the recognition range RA, a distance d′ between the camera road division line CL and the map road division line ML in a range farther than the far end part EP1 is not used for comparison processing, and a distance d in a range nearer than the far end part EP1 is used for comparison processing, for example. Accordingly, it is possible to prevent a situation in which inconsistency between the camera road division line CL and the map road division line ML is judged by the misrecognition of the camera road division line CL which has occurred due to the gradient of the curved road and the driving mode is downgraded. In FIG. 4, as an example, the point EP1 at which the deviation ΔY becomes a prescribed value is set as the far end part EP1 without any change. However, the present invention is not limited to such a constitution, and a spot offset to the near side or the far side in the proceeding direction X of the host vehicle M by a predetermined distance from the point EP1 at which the deviation ΔY becomes a prescribed value may be set as the far end part EP1.

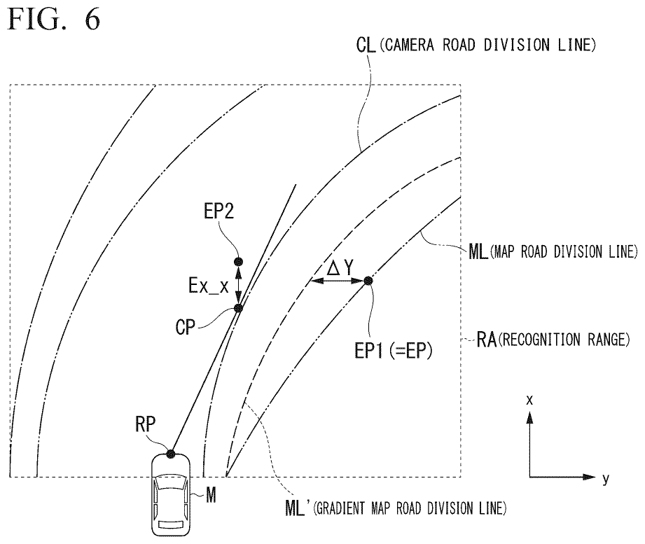

FIG. 5 is a view of showing another example of a scene of the judgment processing executed by the judgment unit 132. FIG. 4 shows a method for coping with an error in the camera road division line CL caused by the gradient of the curved road. Meanwhile, FIG. 5 shows a method for coping with an error in the camera road division line CL caused by the significant curving degree of the curved road (that is, the radius of curvature is small). More specifically, in the camera road division line CL, recognition accuracy is generally low in the proceeding direction X, and as the curving degree of the curved road increases, an influence on a distance measurement error in the vehicle width direction Y caused by an error in the recognition accuracy in the proceeding direction X increases. In other words, for instance, even when the error in the recognition accuracy in the proceeding direction X is small, the distance measurement error in the vehicle width direction Y increases due to the significant curving degree of the curved road. As a result, this is likely to lead to judgment of inconsistency between the camera road division line CL and the map road division line ML (misrecognition of the camera road division line CL). According to the method shown in FIG. 5, it is easy avoid judgment of inconsistency between the camera road division line CL and the map road division line ML by restricting the recognition range RA taking into account the relationship between the error in the recognition accuracy in the proceeding direction X and the distance measurement error in the vehicle width direction Y.

More specifically, while the host vehicle M is traveling on a curved road, the judgment unit 132 first identifies a contact point CP between a reference line having a reference point RP in the host vehicle M as a starting point and the camera road division line CL on the inward side (the side which is more stable with respect to the curving degree of the curved road) in the curved road. Here, for example, the reference point RP may be a predetermined position in the front end part of the host vehicle M (for example, an installation position of the camera 10) or may be the centroid or the like. Next, the judgment unit 132 sets a point EP2 at a predetermined distance Ex_x far away from the position of the identified contact point CP in the proceeding direction X of the host vehicle M as the far end part of the range for matching the camera road division line CL and the map road division line ML.

Next, the judgment unit 132 judges whether or not the camera road division line CL and the map road division line ML are consistent with each other in the range nearer than the far end part EP2 in the proceeding direction X of the host vehicle M in the recognition range RA. In the foregoing algorithm, the far end part EP2 is set on the nearer side in the proceeding direction X of the host vehicle M as the curving degree of the curved road increases (as the radius of curvature decreases). Accordingly, in the case of FIG. 5, in the recognition range RA, the distance d′ between the camera road division line CL and the map road division line ML in a range farther than the far end part EP2 is not used for comparison processing, and the distance d in a range nearer than the far end part EP2 is used for comparison processing, for example. Accordingly, it is possible to prevent a situation in which inconsistency between the camera road division line CL and the map road division line ML is judged by the misrecognition of the camera road division line CL which has occurred due to the curving degree of the curved road and the driving mode is downgraded.

In FIGS. 4 and 5, the recognition range RA for matching the camera road division line CL and the map road division line ML is restricted in order to cope with the misrecognition of the camera road division line CL caused by the gradient and the curving degree of the curved road, respectively. In the present embodiment, in order to simultaneously cope with the misrecognition of the camera road division line CL caused by these two factors, the judgment unit 132 selects the far end part, of the far end part EP1 and the far end part EP2 which have been calculated, positioned on the nearer side in the proceeding direction X of the host vehicle M. In this case, the far end part EP1 is an example of “a first candidate” in the claims, and the far end part EP2 is an example of “a second candidate” in the claims.

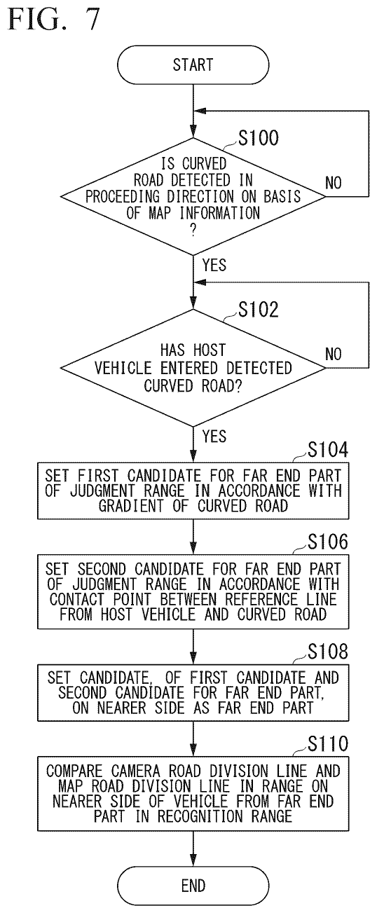

FIG. 6 is an explanatory view of the method for selecting a far end part by the judgment unit 132. FIG. 6, as an example, shows a situation in which the map road division line deviates from the camera road division line and the gradient map road division line due to the upward gradient of the curved road where the host vehicle M is traveling. As shown in FIG. 6, the judgment unit 132 calculates the far end part EP1 at which the deviation ΔY between the map road division line ML and the gradient map road division line ML′ in the vehicle width direction Y becomes equal to or greater than a predetermined value while the host vehicle M is traveling on a curved road and simultaneously calculates the far end part EP2 at the predetermined distance Ex x in the proceeding direction X of the host vehicle M far away from the position of the contact point CP between the reference line having the reference point RP in the host vehicle M as the starting point and the camera road division line CL on the inward side in the curved road. Next, the judgment unit 132 sets the far end part, of the far end part EP1 and the far end part EP2 which have been calculated, positioned on the nearer side in the proceeding direction X of the host vehicle M as the far end part EP which will be eventually used. For example, in the case of FIG. 6, the judgment unit 132 judges that the far end part EP1 is positioned on the nearer side in the proceeding direction X of the host vehicle M and sets it as the far end part EP which will be eventually used.

Next, the judgment unit 132 judges whether or not the camera road division line CL and the map road division line ML are consistent with each other in a range nearer than the far end part EP in the proceeding direction X of the host vehicle M in the recognition range RA. Accordingly, according to the present embodiment, it is possible to prevent a situation in which inconsistency between the camera road division line CL and the map road division line ML is judged by the misrecognition of the camera road division line CL which has occurred due to the gradient and the curving degree of the curved road and the driving mode is downgraded.

In FIG. 4, the gradient map road division line ML′, the camera road division line CL, and the map road division line ML are disposed in order from the turning inward side. Meanwhile, in FIG. 6, the map road division line ML, the gradient map road division line ML′, and the camera road division line CL are disposed in order from the turning inward side. When the map road division line ML is disposed on the outermost side with respect to turning, this means that the curved road has a downward gradient. Meanwhile, when the map road division line ML is disposed on the innermost side with respect to turning, this means that the curved road has an upward gradient. The order relationship between the gradient map road division line ML′ and the camera road division line CL may vary depending on actual recognition results by the camera 10.

Next, with reference to FIG. 7, a flow of processing executed by the judgment unit 132 will be described. FIG. 7 is a flowchart showing an example of a flow of processing executed by the judgment unit 132. The processing shown in the flowchart of FIG. 7 is repeatedly executed by the judgment unit 132 while the host vehicle M is traveling in a driving mode in which autonomous driving or driving assistance is executed.

First, the judgment unit 132 judges whether or not the presence of a curved road is detected in the proceeding direction of the host vehicle M on the basis of the second map information 62 (Step S100). When it is judged that the presence of a curved road is not detected in the proceeding direction of the host vehicle M, the judgment unit 132 executes the processing of Step S100 again after a certain period of time has elapsed.

Meanwhile, when it is judged that the presence of a curved road is detected in the proceeding direction of the host vehicle M, next, the judgment unit 132 judges whether or not the host vehicle M has entered the curved road (Step S102). When it is judged that the host vehicle M has not entered the curved road, the judgment unit 132 executes the processing of Step S102 again after a certain period of time has elapsed.

Next, the judgment unit 132 sets the first candidate for the far end part of the judgment range in accordance with the gradient of the curved road (Step S104). Next, the judgment unit 132 sets the second candidate for the far end part of the judgment range in accordance with the contact point between the reference line from the host vehicle M and the curved road (Step S106). Next, the judgment unit 132 sets the candidate, of the first candidate and the second candidate for the far end part, on the nearer side in the proceeding direction X of the host vehicle M as the far end part (Step S108). Next, the judgment unit 132 compares the camera road division line and the map road division line in the range on the nearer side of the host vehicle M from the far end part in the recognition range by the camera 10 (Step S110). Accordingly, the processing of the present flowchart ends.

In the foregoing flowchart, for the sake of convenience, the second candidate for the far end part is set after the first candidate for the far end part is set. However, the present invention is not limited to such a constitution, and the judgment unit 132 may set the first candidate and the second candidate for the far end part in the reverse order or may set them simultaneously in parallel. Through the processing of the foregoing flowchart, when the judgment unit 132 judges that the camera road division line and the map road division line are consistent with each other, the mode determination unit 150 continues autonomous driving or driving assistance by the current driving mode. Meanwhile, when the judgment unit 132 judges that the camera road division line and the map road division line are not consistent with each other, the mode determination unit 150 downgrades the driving mode or continues the current driving mode by giving priority to the map road division line.

According to the present embodiment described above, when the vehicle is traveling on a curved road, the judgment unit sets a distance from the vehicle to the far end part on a side in the proceeding direction of the vehicle of the judgment range in which judgment is performed to be shorter than the distance when the vehicle is not traveling on a curved road. Accordingly, the recognition range of the camera road division line can be appropriately set while the host vehicle is traveling on a curved road.

### MODIFICATION EXAMPLE

In the foregoing embodiment, the judgment unit 132 sets the first candidate EP1 and the second candidate EP2 for the far end part using the deviation ΔY between the map road division line ML and the gradient map road division line ML′ in the vehicle width direction Y, and the contact point CP between the reference line having the reference point RP in the host vehicle M as the starting point and the camera road division line CL on the inward side in the curved road. As a modification example, the judgment unit 132 may set a third candidate EP3 for the far end part more simply in accordance with the curving degree of the curved road without going through the foregoing calculation processing and may set the candidate, of at least two of the first candidate EP1, the second candidate EP2, and the third candidate EP3 for the far end part, present on the nearer side of the host vehicle M as the far end part EP.

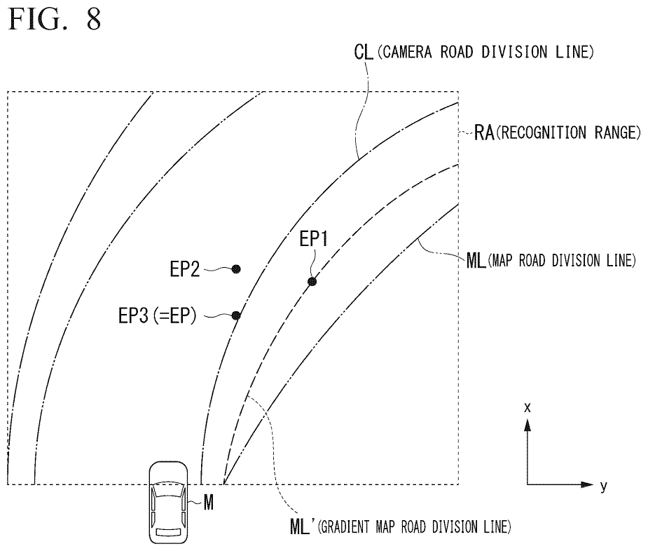

FIG. 8 is an explanatory view of the method for selecting the far end part by the judgment unit 132 according to a modification example. Similar to FIG. 6, FIG. 8 shows a situation in which the map road division line deviates from the camera road division line and the gradient map road division line due to the upward gradient of the curved road where the host vehicle M is traveling. As shown in FIG. 8, the judgment unit 132 calculates the curvature or the radius of curvature as the curving degree of the camera road division line CL or the map road division line ML which has been recognized, for example, while the host vehicle M is traveling on a curved road, and the third candidate EP3 whose distance from the host vehicle M is set to be smaller as the calculated curvature increases or the radius of curvature decreases is set on the camera road division line CL or the map road division line ML. Next, the judgment unit 132 sets the far end part, of the first candidate EP1, the second candidate EP2, and the third candidate EP3 for the far end part, positioned on the nearer side in the proceeding direction X of the host vehicle M as the far end part EP which will be eventually used.

For example, in the case of FIG. 8, the judgment unit 132 judges that the far end part EP3 is positioned on the nearer side in the proceeding direction X of the host vehicle M and sets it as the far end part EP which will be eventually used.

Next, the judgment unit 132 judges whether or not the camera road division line

CL and the map road division line ML are consistent with each other in a range nearer than the far end part EP in the proceeding direction X of the host vehicle M in the recognition range RA. Accordingly, according to the present modification example, it is possible to more reliably prevent a situation in which inconsistency between the camera road division line CL and the map road division line ML is judged and the driving mode is downgraded.

The embodiment described above can be expressed as follows.

A judgment device constituted to include a storage device storing a program, and a hardware processor. The hardware processor executes the program to recognize a road division line present in a proceeding direction of a vehicle, to judge whether or not the recognized road division line is consistent with a map road division line based on map information stored in a storage unit, and to set, when the vehicle is traveling on a curved road, a distance from the vehicle to a far end part on a side in the proceeding direction of the vehicle of a judgment range in which the judgment is performed to be shorter than the distance when the vehicle is not traveling on a curved road.

Hereinabove, forms for performing the present invention have been described using an embodiment. However, the present invention is not limited to such an embodiment in any way, and various modifications and replacements can be added thereto within a range not departing from the gist of the present invention.

What is claimed is:

1. A judgment device comprising:
a storage medium storing computer readable commands; and
a processor connected to the storage medium,
wherein the processor executes the computer readable commands
to recognize a road division line present in a proceeding direction of a vehicle, and
to judge whether or not the recognized road division line is consistent with a map road division line based on map information stored in a storage unit, and
when the vehicle is traveling on a curved road, the processor sets a distance from the vehicle to a far end part on a side in the proceeding direction of the vehicle of a judgment range in which the judgment is performed to be shorter than the distance when the vehicle is not traveling on a curved road.

2. The judgment device according to claim 1,
wherein the processor sets the distance to the far end part of the judgment range in accordance with a gradient of the curved road.

3. The judgment device according to claim 2,
wherein the processor sets, as the distance to the far end part, a distance to a position where a difference in a vehicle width direction between the map road division line and a gradient map road division line obtained by correcting the map road division line in accordance with the gradient becomes equal to or greater than a predetermined value.

4. The judgment device according to claim 2,
wherein the processor sets, as the distance to the far end part, a distance to a position at a predetermined distance near from a position where a difference in a vehicle width direction between the map road division line and a gradient map road division line obtained by correcting the map road division line in accordance with the gradient becomes equal to or greater than a predetermined value.

5. The judgment device according to claim 1,
wherein the processor identifies a contact point where a line extending from a predetermined position in the vehicle comes into contact with a road division line of the recognized road division lines on an inward side of the curved road, and
the processor sets the distance to the far end part of the judgment range in accordance with a position of the contact point.

6. The judgment device according to claim 5,
wherein the processor sets, as the distance to the far end part, a distance to a position at a predetermined distance far away from the position of the contact point of the judgment range.

7. The judgment device according to claim 1,
wherein the processor sets the distance to the far end part of the judgment range in accordance with a curving degree of the curved road.

8. The judgment device according to claim 7,
wherein the processor shortens the distance to the far end part as the curving degree of the curved road increases.

9. The judgment device according to claim 1,
wherein the processor identifies a contact point where a line extending from a predetermined position in the vehicle comes into contact with a road division line of the recognized road division lines on an inward side of the curved road,
the processor sets a first candidate for the far end part in accordance with a gradient of the curved road, sets a second candidate for the far end part in accordance with a position of the contact point, and sets a third candidate for the far end part in accordance with a curving degree of the curved road, and
the processor sets, as the far end part, a candidate of at least two of the first candidate, the second candidate, and the third candidate present on a side near the vehicle.

10. The judgment device according to claim 9,
wherein the processor sets, as the first candidate, a position where a difference in a vehicle width direction between the map road division line and a gradient map road division line obtained by correcting the map road division line in accordance with the gradient becomes equal to or greater than a predetermined value, and the processor sets, as the second candidate, a position at a predetermined distance far away from the position of the contact point.

11. The judgment device according to claim 9,
wherein the processor sets, as the third candidate, a position set in accordance with the curving degree of the curved road.

12. The judgment device according to claim 10,
wherein the processor sets, as the third candidate, a position set in accordance with the curving degree of the curved road.

13. A judgment method in which a computer mounted in a vehicle
recognizes a road division line present in a proceeding direction of the vehicle,
judges whether or not the recognized road division line is consistent with a map road division line based on map information stored in a storage unit, and
sets, when the vehicle is traveling on a curved road, a distance from the vehicle to a far end part on a side in the proceeding direction of the vehicle of a judgment range in which the judgment is performed to be shorter than the distance when the vehicle is not traveling on a curved road.

14. A computer readable non-transitory storage medium storing a program for causing a computer mounted in a vehicle
to recognize a road division line present in a proceeding direction of the vehicle,
to judge whether or not the recognized road division line is consistent with a map road division line based on map information stored in a storage unit, and
to set, when the vehicle is traveling on a curved road, a distance from the vehicle to a far end part on a side in the proceeding direction of the vehicle of a judgment range in which the judgment is performed to be shorter than the distance when the vehicle is not traveling on a curved road.
